(19) United States
(12) Patent Application Publication
(10) Pub. No.: US 2018/0189903 A1
(43) Pub. Date: Jul. 5, 2018

(54) SYSTEM TO MONITOR AND PROVIDE ALERTS AFFECTING TITLE OF REAL ESTATE

(71) Applicant: Robert PALMER, Lake Mary, FL (US)

(72) Inventor: Robert PALMER, Lake Mary, FL (US)

(21) Appl. No.: 15/861,991

(22) Filed: Jan. 4, 2018

Related U.S. Application Data
(60) Provisional application No. 62/442,113, filed on Jan. 4, 2017.

(51) Int. Cl. G06Q 50/16; G06F 3/0482; G06F 17/30; G06Q 40/08; H04W 4/12

(52) U.S. Cl. CPC G06Q 50/16; G06F 3/0482; H04W 4/12; G06Q 40/08; G06F 17/30864; G06F 17/30241

(57) ABSTRACT

A system to monitor and provide alerts of events affecting title of real estate includes a remote computer of a user, a GUI installed on the remote computer of the user, a data source, and a transmission server configured to receive title event data from the data source over a communications network pursuant to a transmission schedule. The transmission server includes a microprocessor configured to filter the received title event data for title event data for the selected piece of real estate, generate a title event alert from the filtered data that contains the identity of the selected piece of real estate and a description of the filtered title event data for the selected piece of real estate, format the title event alert into data blocks according to the information format, and transmit the formatted title event alert over the communications network to the remote computer.

### RELATED APPLICATION

The present invention is related to U.S. Provisional Patent Application Ser. No. 62/442,113 filed Jan. 4, 2017, the entire contents of which are incorporated herein by reference.

### FIELD

The present invention relates to the field of real estate, and, more particularly, to a system to monitor and provide alerts affecting title of real estate and related methods.

### BACKGROUND

A search of public land records for matters affecting the title to the real estate is performed as part of the process of purchasing real estate. The search is intended to report relevant issues related to the title of the particular piece of real estate. Instruments that can affect the title are found in the chain, or history, of ownership assembled from the records in a search. Examples of instruments that can create encumbrances on the title include open permits, deeds, wills, trusts, mortgage liens, judgment liens, tax liens, and easements.

The encumbrances may be cured in some cases. However, this takes additional time and money to resolve, which could lead to impacting the sale of the real estate. Also, additional problems can arise even after completion of a real estate transaction. For example, these hidden problems may include a forged deed that transfers no title to real estate, previously undisclosed heirs with claims against the property, instruments executed under expired or fabricated power of attorney, and mistakes in the public records.

A routine step in preparing for the closing of a real estate transaction is to perform the title search for these encumbrances. The real estate serves as security for the financing and proof of title is required to identify the correct owner or owners of interests in the real estate as well as to identify any encumbrances. The parties to the transaction typically hire a title insurance company, a title search agent, or an attorney to provide such proof.

A search of all the recorded title-related documents for the property is performed in order to obtain proof of title. The search may be performed manually at a local government repository or a private title plant, for example. The results of the search may show items such as the current owner of the real estate, record owners of easement or other access rights on, over or under the real estate, and holders of mortgage interests in the real estate, and encumbrances recorded against the real estate. The search of recorded documents typically includes a search of all records of interests held during the past several decades, or going back to a prior effective title insurance policy existed, or another sufficient beginning point.

Title affecting events may be recorded against a piece of real estate by third parties without the consent and knowledge of the owner. However, a title search as described above can be time consuming and costly to constantly perform to discover these title affecting events in real-time. Accordingly, a system is needed where events affecting title to a piece of property can be monitored for in real-time in order for the owner to remedy any potential problems quickly and efficiently without first having to perform a full title search to identify a potential issue.

### SUMMARY

In view of the foregoing background, it is therefore an object of the present invention to provide a system to monitor and provide alerts of events affecting title of real estate. The system includes a remote computer of a user, a graphical user interface (“GUI”) installed on the remote computer of the user, a data source, and a transmission server configured to receive title event data from the data source over a communications network pursuant to a transmission schedule

The transmission server includes a microprocessor and a memory that stores a user's destination address and preferred information format, and an identity of a selected piece of real estate. The microprocessor is configured to filter the received title event data for title event data for the selected piece of real estate, generate a title event alert from the filtered data that contains the identity of the selected piece of real estate and a description of the filtered title event data for the selected piece of real estate, format the title event alert into data blocks according to the information format, and transmit the formatted title event alert over the communications network to the remote computer based upon the destination address. In addition, the system includes that the formatted title event alert activates the GUI to display the description of the title event on the remote computer.

In another embodiment, a method to monitor and provide alerts of events affecting title of real estate is disclosed. The method includes providing a graphical user interface (“GUI”) to a user for installation on a remote computer, associating a selected piece of real estate with the user and receiving title event data at a transmission server sent from a data source over a communications network pursuant to a transmission schedule.

The transmission server includes a microprocessor and a memory that stores the user's destination address and preferred information format, and an identity of the selected piece of real estate. The microprocessor is configured to filter the received title event data for title event data for the selected piece of real estate, generate a title event alert from the filtered data that contains the identity of the selected piece of real estate and a description of the filtered title event data for the selected piece of real estate, format the title event alert into data blocks according to the information format, and transmit the formatted title event alert over the communications network to the remote computer based upon the destination address. The formatted title event alert activates the GUI to display the description of the title event on the remote computer.

One advantage of a particular illustrative embodiment of the invention, is that an owner of a piece of real estate is able to continually monitor for any events that are recorded against it, which and can then be resolved immediately rather than first discovering years later when trying to sell or use the real estate for security, for example.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a flow diagram of a particular illustrative embodiment of method to monitor and provide alerts of events affecting title of real estate;

FIG. 2 is a diagram of a particular illustrative embodiment of a system to monitor and provide alerts of events affecting title of real estate where an interface application (e.g., “GUI”) resides on a user's remote computer;

FIG. 3 is a general diagram of a system incorporating a microprocessor and a memory in which the system and method of FIGS. 1 and 2 to monitor and provide alerts of events affecting title of real estate may be used; and

FIG. 4 is a particular illustrative embodiment of a graphical user interface (“GUI”) that may be used with the system and method to monitor and provide alerts of events affecting title of real estate.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

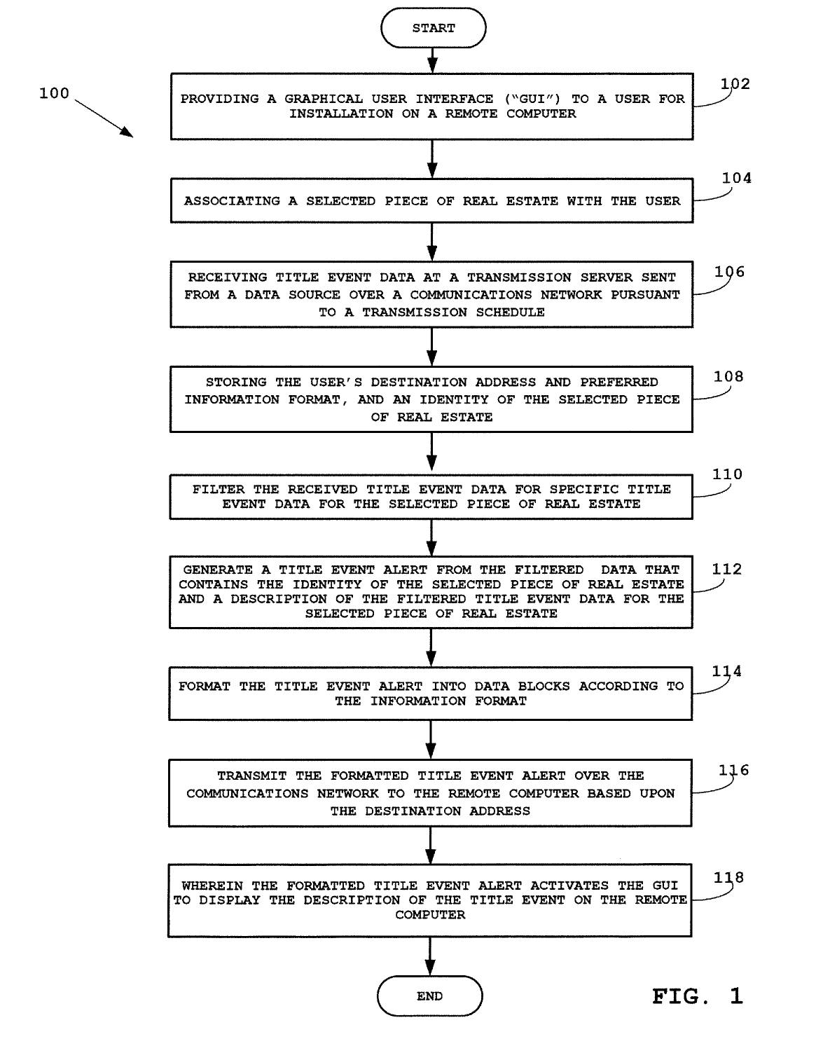

Referring initially to FIG. 1, a method to monitor and provide alerts of events affecting title of real estate is generally designated 100. The method begins with providing a graphical user interface (“GUI”) to a user for installation on a remote computer, at 102. Moving to 104, the method includes associating a selected piece of real estate with the user.

In addition, the method includes, at 106, receiving title event data at a transmission server sent from a data source over a communications network pursuant to a transmission schedule. The method also includes storing the user's destination address and preferred information format, and an identity of the selected piece of real estate, at 108.

The method includes filtering the received title event data for specific title event data for the selected piece of real estate, at 110. At 112, the method includes generating a title event alert from the filtered data that contains the identity of the selected piece of real estate and a description of the filtered title event data for the selected piece of real estate, and formatting the title event alert into data blocks according to the information format, at 114. In addition, the method includes transmitting the formatted title event alert over the communications network to the remote computer based upon the destination address, at 116, where, at 118, the formatted title event alert activates the GUI to display the description of the title event on the remote computer. The microprocessor may also provide an alert to a wireless device associated with the user, where the wireless device has a similar GUI for displaying the title event alert.

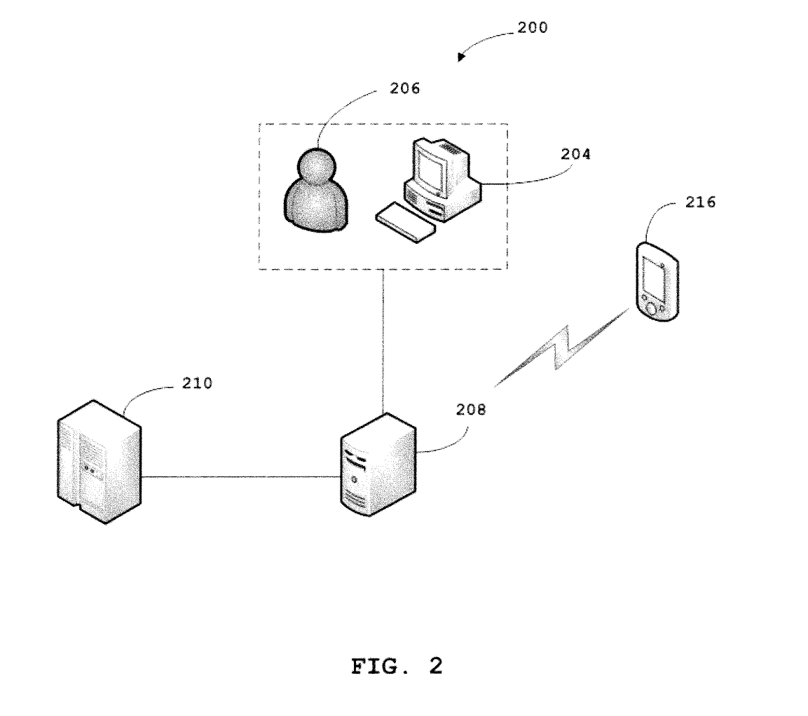

Referring to FIG. 2, a system to monitor and provide alerts of events affecting title of real estate is shown and designated 200. The system 200 includes a remote computer 204 in communication with a transmission server 208. A wireless device 216 of the user may also be used instead of, or in addition to, the remote computer 204 in the system. A user 206 uses a GUI installed on the remote computer 204 (or the wireless device 216) in order to enter the identity of a particular piece of real estate that should be monitored for events affecting title. Typically, the piece of real estate would be owned by the user 206 who may be considering listing the real estate for sale and wants to maintain clear title.

The transmission server 208 is in communication with a data source 210 using the Internet or a wireless communication network, for example. The data source 210 stores information related to events and instruments that could affect the title to the real estate. The data source may be serviced by a third-party, in a particular embodiment, who compiles the data and makes it available on a subscription basis. However, the data could also be stored directly on the transmission server 208 in another particular embodiment.

For example, the data source 210 may include a plurality of databases. This could include one more of a title insurance claims database, tax liens database, and court judgments.

The title insurance claims database lists claims made against title insurance policies for a piece of real estate. The tax liens database contains tax information relating to whether a tax lien has been filed against the real estate. The court judgments database contains information obtained from various court jurisdictions. For example, this could include foreclosures, credit card or loan defaults, breaches of contract, bankruptcies, and child support orders that resulted in a lien or attachment on the real estate. Other databases may be used as part of the data source 210 to identify events and instruments that could affect title to the real estate. The information obtained from the various databases that serve as the data source 210 may be used to initiate the title event alert.

In addition, a wireless user device 216, such as a smartphone for example, may be in communication with the transmission server 208. The wireless user device 216 may be controlled by the owner of the real estate, a title agency, or a real estate broker in order to monitor for encumbrances on the title while in escrow, for example.

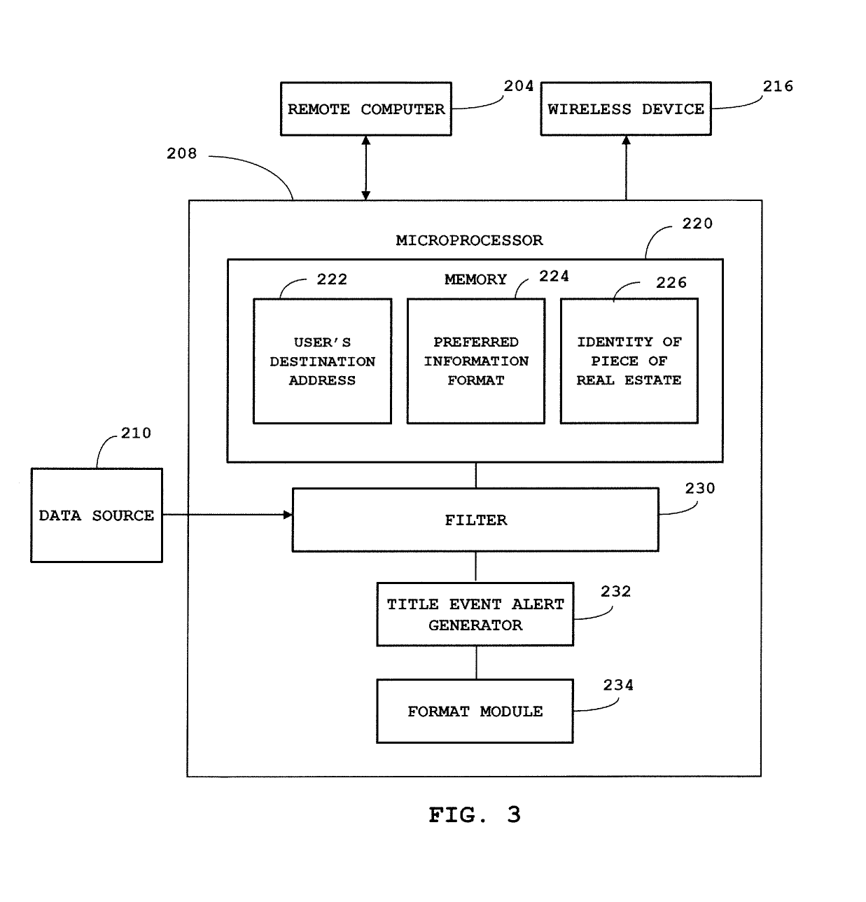

FIG. 3 is a general diagram of the transmission server 208, which includes a microprocessor and a memory 220. The memory 220 is used to store a user's destination address (e.g., IP address) 222, preferred information format 224, and identity of the selected piece of real estate 226. A filter algorithm 230 is executed by the microprocessor in order to filter the received data from the data source 210 for events affecting the selected piece of real estate. Once the received data is filtered, a title event alert algorithm 232 is executed in order to generate the alert. A format module 234 is used to format the title event alert and to initiate the transmission to the remote computer 204. The title defect alert can also be transmitted to a wireless device 216.

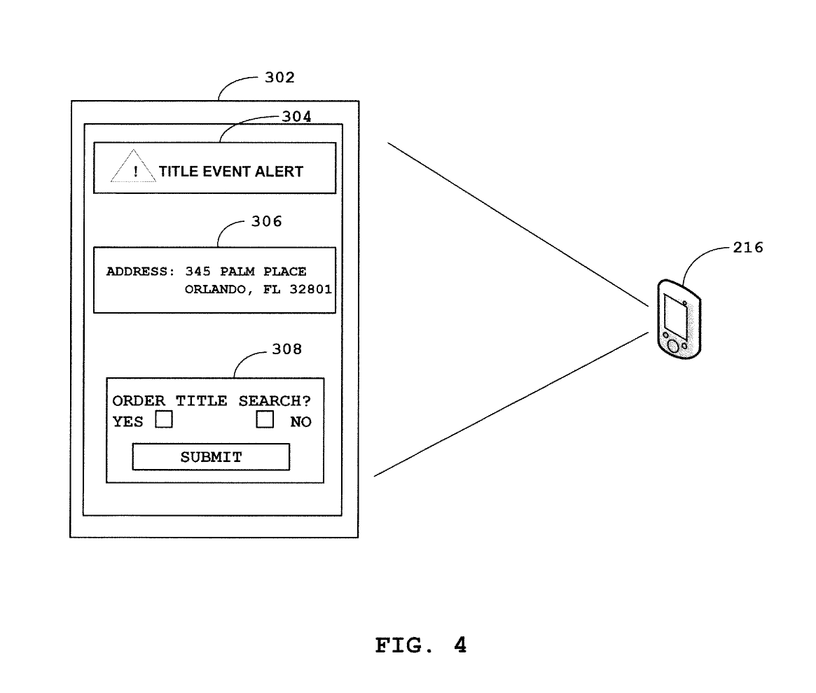

A title event alert 304 is shown in FIG. 4 on a graphical user interface (“GUI”) 302 of the wireless device 216. The title event alert 304 could also be displayed on the remote computer 204. The title event alert 304 is a notification that the system has detected an event that may affect the title to a piece of real estate. Also included with the title event alert 304 is the address 306 of the piece of real estate associated with the title event alert 304. A graphical map of the location of the piece of real estate could also be shown on the GUI 302. The user may also have the ability to select whether to order a title search 308 using a selection menu 308 to discover the description of the event that triggered the alert.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined herein.

That which is claimed is:

1. A system to monitor and provide alerts of events affecting title of real estate comprising:
a remote computer of a user;
a graphical user interface (“GUI”) installed on the remote computer of the user;
a data source;
a transmission server configured to receive title event data from the data source over a communications network pursuant to a transmission schedule;
the transmission server comprising a microprocessor and a memory that stores a user's destination address and preferred information format, and an identity of a selected piece of real estate, wherein the microprocessor is configured to
filter the received title event data for title event data for the selected piece of real estate,
generate a title event alert from the filtered data that contains the identity of the selected piece of real estate and a description of the filtered title event data for the selected piece of real estate,
format the title event alert into data blocks according to the information format, and
transmit the formatted title event alert over the communications network to the remote computer based upon the destination address,
wherein the formatted title event alert activates the GUI to display the description of the title event on the remote computer.

2. The system to monitor and provide alerts of events affecting title of real estate of claim 1, wherein the remote computer is a wireless device.

3. The system to monitor and provide alerts of events affecting title of real estate of claim 1, wherein the communications network comprises a wireless communications channel.

4. The system to monitor and provide alerts of events affecting title of real estate of claim 1, wherein the data source comprises at least one of a title insurance claims database, tax liens database, and court judgments database.

5. The system to monitor and provide alerts of events affecting title of real estate of claim 1, wherein the user's destination address is an Internet Protocol (IP) address.

6. The system to monitor and provide alerts of events affecting title of real estate of claim 1, wherein the transmission server is in communication with the data source using an Internet or a wireless communication network.

7. The system to monitor and provide alerts of events affecting title of real estate of claim 1, wherein the title event alert comprises an address of the piece of real estate associated with the title event alert.

8. The system to monitor and provide alerts of events affecting title of real estate of claim 7, wherein the title event alert comprises a graphical map of a location of the piece of real estate.

9. The system to monitor and provide alerts of events affecting title of real estate of claim 8, wherein the title event alert comprises a selection menu in order to initiate a full title search using the data source.

10. A method to monitor and provide alerts of events affecting title of real estate comprising:
providing a graphical user interface (“GUI”) to a user for installation on a remote computer;
associating a selected piece of real estate with the user;
receiving title event data at a transmission server sent from a data source over a communications network pursuant to a transmission schedule, the transmission server comprising a microprocessor and a memory that stores the user's destination address and preferred information format, and an identity of the selected piece of real estate, wherein the microprocessor is configured to
filter the received title event data for title event data for the selected piece of real estate,
generate a title event alert from the filtered data that contains the identity of the selected piece of real estate and a description of the filtered title event data for the selected piece of real estate,
format the title event alert into data blocks according to the information format, and
transmit the formatted title event alert over the communications network to the remote computer based upon the destination address,
wherein the formatted title event alert activates the GUI to display the description of the title event on the remote computer.

11. The method to monitor and provide alerts of events affecting title of real estate of claim 10, wherein the remote computer is a wireless device.

12. The method to monitor and provide alerts of events affecting title of real estate of claim 10, wherein the communications network comprises a wireless communications channel.

13. The method to monitor and provide alerts of events affecting title of real estate of claim 10, wherein the data source comprises at least one of a title insurance claims database, tax liens database, and court judgments database.

14. The method to monitor and provide alerts of events affecting title of real estate of claim 10, wherein the user's destination address is an Internet Protocol (IP) address.

15. The method to monitor and provide alerts of events affecting title of real estate of claim 10, wherein the transmission server is in communication with the data source using an Internet or a wireless communication network.

16. The method to monitor and provide alerts of events affecting title of real estate of claim 10, wherein the title event alert comprises an address of the piece of real estate associated with the title event alert.

17. The method to monitor and provide alerts of events affecting title of real estate of claim 16, wherein the title event alert comprises a graphical map of a location of the piece of real estate.

18. The method to monitor and provide alerts of events affecting title of real estate of claim 17, wherein the title event alert comprises a selection menu in order to initiate a full title search using the data source.

19. A system to monitor and provide alerts of events affecting title of real estate comprising:
a remote computer of a user; and
a transmission server comprising a microprocessor and a memory, and configured to receive title event data from a data source over a communications network pursuant to a transmission schedule, and stores a user's destination address and preferred information format, and an identity of a selected piece of real estate, wherein the microprocessor is configured to
filter the received title event data for title event data for the selected piece of real estate, and
generate a title event alert from the filtered data that contains the identity of the selected piece of real estate and a description of the filtered title event data for the selected piece of real estate.

20. The system to monitor and provide alerts of events affecting title of real estate of claim 19, wherein the microprocessor is configured to format the title event alert into data blocks, and transmit the formatted title event alert over the communications network to the remote computer based upon the user's destination address, wherein the formatted title event alert activates a GUI on the remote computer to display the description of the filtered title event data.
